(19) United States
(12) Patent Application Publication
(10) Pub. No.: US 2006/0174345 A1
(43) Pub. Date: Aug. 3, 2006

(54) Apparatus and method for acceleration of malware security applications through pre-filtering

(75) Inventors: Michael Flanagan, Newtown (AU); Peter Duthie, Engadine (AU); Peter Bisroev, Coogee South (AU); Teewoon Tan, Roseville (AU); Darren Williams, Newtown (AU); Robert Matthew Barrie, Double Bay (AU); Stephen Gould, Killara (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks, Inc., Palo Alto, CA (US)

(21) Appl. No.: 11/291,511

(22) Filed: Nov. 30, 2005

Related U.S. Application Data
(60) Provisional application No. 60/632,240, filed on Nov. 30, 2004.

(51) Int. Cl. G06F 12/14

(52) U.S. Cl. 726/24

(57) ABSTRACT

A data classification system identifies and processes malicious data that may be present in a received data stream. The system includes at least two stages, and a data flow module. The data flow module derives, from an input data stream, a first processed data stream that is transmitted to the first processing stage. The first processing stage derives, from the first processed data stream, a second processed data stream that is transmitted to the second processing stage. The first and second processing stages optionally derive meta data from the data they receive.

### CROSS-REFERENCES TO RELATED APPLICATIONS

The present application claims benefit under 35 USC 119(e) of U.S. provisional application No. 60/632240, file Nov. 30, 2004, entitled “Apparatus and Method for Acceleration of Security Applications Through Pre-Filtering”, the content of which is incorporated herein by reference in its entirety.

The present application is also related to copending application Ser. No. ______, entitled “Apparatus And Method For Acceleration Of Security Applications Through Pre-Filtering”, filed contemporaneously herewith, attorney docket no. 021741-001810US; copending application Ser. No. ______, entitled “Apparatus And Method For Acceleration Of Electronic Message Processing Through Pre-Filtering”, filed contemporaneously herewith, attorney docket no. 021741-001820US; copending application Ser. No. ______, entitled “Apparatus And Method For Accelerating Intrusion Detection And Prevention Systems Using Pre-Filtering”, filed contemporaneously herewith, attorney docket no. 021741-001840US; all assigned to the same assignee, and all incorporated herein by reference in their entirety.

### BACKGROUND OF THE INVENTION

The present invention relates generally to the area of processing electronic data. More specifically, the present invention relates to systems and methods for identifying and processing malicious data within electronic messages or other data.

In the last twenty years, the Internet has changed from a research network to a ubiquitous communication medium that enables a diverse range of useful applications. This increase in the direct and indirect use of the Internet, the rapid increase in the amount of data exchanged between those connected to the Internet and the generally homogenous nature of the systems through which the Internet is accessed by end users, has lead to a huge increase in the presence and transmission of malicious data.

The transmission and reception of increasingly large amounts of malicious data has several important consequences. The presence of malicious data on machines connected to the Internet can seriously impede the security and utility of such systems. Secondly, such malicious data often contains autonomous vectors for replication and retransmission that can lead to exponential replication that can seriously impede the information transfer functionality of the Internet itself.

FIG. 1 depicts a typical prior art implementation of a malicious data scanning system, operating on data present on disk storage 110. The system extracts the data from the disk as discrete files 120 which are then passed on to a typical antivirus system 130. The antivirus system 130 uses expressions or templates, stored in a signature database, to identify the presence of malicious code or data in the inspected files. The system processes any such malicious data by generating alert messages or quarantining the suspect files.

FIG. 2 depicts a typical prior art implementation of a virus scanning system integrated into an electronic mail transfer system. A Mail Transfer Agent 230 performs antivirus checking on electronic message before they reach the destination mailbox 250. The checking operation allows for the redirection of infected messages to a quarantine area as well as the modification of messages to remove, or mitigate the effects of, malicious contents. This pre-delivery scanning of email is typically used to protect email users from such malicious data as embedded viruses, spyware, “phishing” scams and other embedded operating system specific exploits.

In recognition of the inconvenience and data loss that may be caused by malicious data and code, the deliberate production and release of such data or code is now illegal in many countries. Nevertheless, it is still commonplace for large outbreaks of malicious code to affect millions of people world wide. The pervasiveness of such outbreaks in technology enabled societies is highlighted by the fact that such incidents are now commonly reported in the general media, not just media catering to technology professionals. With the increasing number and complexity of malicious code and data attacks, it is becoming more and more burdensome to ensure incident free operation of systems connected to the Internet. The need to scan more and more data for an increased number of potential threats is increasing the cost, time and processing power requirements of information security systems.

There is a need for a system and methodology to increase the speed of classifying electronic data as malicious or benign. Such a solution should provide an effective way to reduce the processing burdens on traditional security systems. Any such solution preferably provides a performance increase over traditional approaches without significantly sacrificing overall system accuracy.

### BRIEF SUMMARY OF THE INVENTION

According to the present invention, techniques for searching and classification of electronic data are provided. More particularly the invention provides a method and system for identification and processing of malicious data in electronic data.

One embodiment of the present invention includes a data flow module, a first processing stage, a second processing stage and a reporting module with optional third and fourth processing stages. The data flow module is configured to derive (generate), from an input data stream, a first processed data stream that is transmitted to the first processing stage. The first processing stage is configured to derive, from the first processed data stream, a second processed data stream that is transmitted to the second processing stage. The first and second processing stages are configured to derive meta data that is processed by the reporting module. The reporting module is configured to produce meta data that is further processed by the data flow module, in conjunction with the input data stream, to produce meta data relating to the presence of malicious data in the input data stream.

In one embodiment, the third processing stage receives a processed data stream derived by the data flow module. In one embodiment, the third processing module acts as a quarantine store for the malicious data in the input data stream.

In one embodiment, the fourth processing stage receives a processed data stream derived by the data flow module. In one embodiment, the fourth processing stage includes a disinfecting module configured to remove from its input processed data stream any malicious data that has been identified by the other modules. After removing the malicious data, thereby render the data benign (harmless), the fourth processing stage transmits the data so rendered benign as a further processed data stream.

In one embodiment, the invention processes an input data stream that comprises HTTP traffic, instant messaging traffic, XML encoded data, data stored in disk files or other storage systems, telephony data, and other forms of electronic data.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 depicts a system for scanning of malicious data and code in disk files used in a computer system, as known in the prior art.

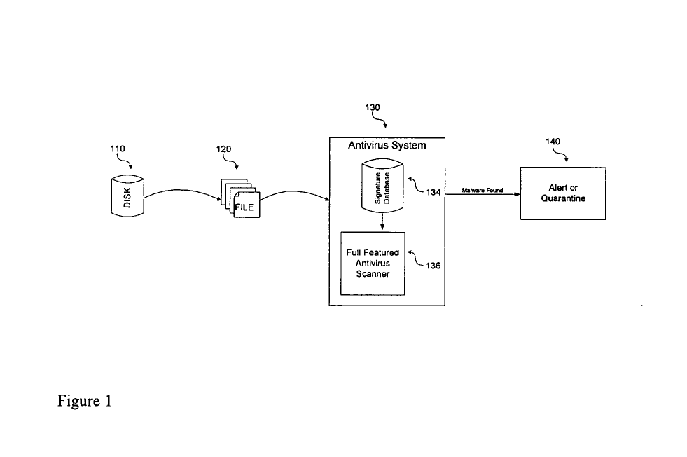

FIG. 2 depicts a system for scanning for malicious data in an electronic mail processing system, as known in the prior art.

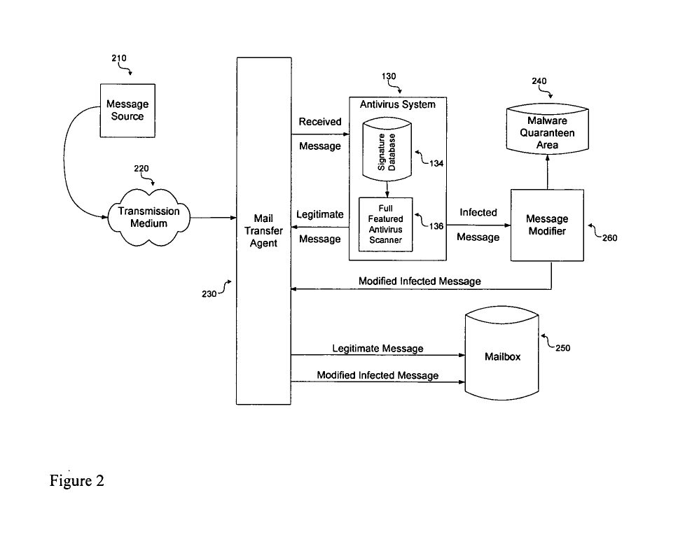

FIG. 3 shows an antivirus pre-filter stage used to further direct the malicious data searching process to one of two specialized anti-virus filter stages, in accordance with one embodiment of the present invention.

FIG. 4 shows an antivirus pre-filter stage used to alleviate the need for passing data through a full-featured antivirus scanner, in accordance with one embodiment of the present invention.

FIG. 5 shows various blocks of a system adapted to extract a derived rule set in the form of a signature subset database from a full featured signature database, in accordance with one embodiment of the present invention.

FIG. 6 shows various blocks of an antivirus pre-filter stage adapted to classify input data as clean, infected or suspect.

FIG. 7 shows various logic blocks of a system adapted to process data using a pair of processing stages, in accordance with one embodiment of the present invention.

FIG. 8 shows various logic blocks of a system adapted to process data using a pair of processing stages, in accordance with one embodiment of the present invention.

FIG. 9 shows various logic blocks of a system adapted to process data using a pair of processing stages, in accordance with one embodiment of the present invention.

### DETAILED DESCRIPTION OF THE INVENTION

For the purposes of searching, classifying or otherwise dealing with data, except where explicitly stated, no distinction is made between data, executable code or anything else that may be represented as digital information. The use of the term “data” is assumed to cover stored data, electronic messages, executable computer code, etc., wherever such interpretation is not excluded by the context in which the term occurs, or otherwise clarified.

Some embodiments of the present invention discussed below make use of meta data. In the context of the invention, meta data is data in addition to or derived from data in one or more data streams, providing information about the data in the data streams, e.g., a classification of the data as benign or malicious. What constitutes malicious data is determined by signatures, patterns or other description characteristics of the data received by the present invention. Meta data may be used to describe or classify other meta data.

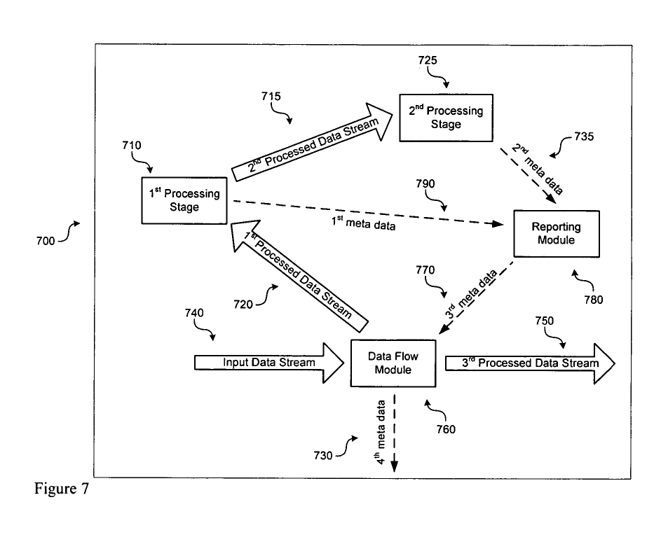

FIG. 7 shows various logical blocks of system 700 adapted to detect malicious data, in accordance with an embodiment of the present invention. System 700 processes input data stream 740 to detect whether it includes any malicious data.

The data in the input data stream 740 is inspected by the data flow module 760. This module dispatches data to the other modules of the system and utilizes the results generated by the other modules to determine what data should be output as the contents of the third processed data stream 750. In an embodiment, the third processed data stream 750 supplied by the system includes the data received by the system 700 with the exception of those parts which have been determined as malicious.

The data flow module 760 outputs a first processed data stream 720 to the first processing stage 710. This data stream is derived by the data flow module 760 from the input data stream 740. In an embodiment, where no preprocessing is required prior to the first processing stage 710, this derivation may be obtained by copying the input data stream 740, and relaying the data from the input data stream 740 to the first processing stage 710.

The first processing stage 710 accepts the first processed data stream 720 from the data flow module 760, deriving from the first processed data stream 720 a second processed data stream 715 and some information about the first processed data stream 720; the derived information being the first meta data 790. This first processing stage 710 acts as a pre-filter for the second processing stage 725. In some embodiments of the invention, the operations performed by the first processing stage 710 alleviate the need to perform significant processing in the second processing stage 725.

In an embodiment, the first processing stage 710 determines that, for at least some portion of the data in the first processed data stream 720, it is not necessary for the data to be processed by the second processing stage 725. In an embodiment, the first processing stage 710 classifies the data in the first processed data stream 720 as malicious, benign or suspicious. In such an embodiment, if the first processing stage 710 determines a classification of either malicious or benign it is not necessary for the data to be further processed by the second processing stage 725. Only data that is classified as suspicious is passed from the first processing stage 710 to the second processing stage 725 in the second processed data stream 715. In such an embodiment, the first processing stage 710 includes the classification result in the first meta data 790 that is passed to the reporting module 780. In such an embodiment, the first processing stage 710 acts as a pre-filter to the second processing stage 725 in that it only passes on to the second processing stage 725 portions of the first processed data stream 720 for which it is unable to determine a malicious or benign classification.

In an embodiment, the second processing stage 725 will classify the data in the second processed data stream 715 as malicious or benign. In such an embodiment, the second processing stage 725 includes this classification in the second meta data 735 transmitted to the reporting module 780.

The reporting module 780 receives both the second meta data 735 and the first meta data 790. In an embodiment, the reporting module 780 receives information about the malicious or benign nature of the input data stream 740 as determined by the first processing stage 710 and second processing stage 725 operating on their respective input processed data streams 720, 715. The reporting module 780 derives a third meta data 770 which is transmitted to the data flow module 760. In an embodiment, this includes a malicious or benign classification of the data in the input data stream 740 derived from the classifications performed by the first processing stage 710 and second processing stage 725. These classifications are included in the first meta data 790 and second meta data 735.

The data flow module 760 derives a third processed data stream 750 and a fourth meta data 730 using the third meta data 770 and the input data stream 740. In an embodiment, the fourth meta data 730 includes a report from the system as to the classification of the input data stream 740, i.e., malicious or benign. The third processed data stream 750 may include a modified version of the input data stream 740 derived using information received in the third meta data 770. In an embodiment, if the third meta data 770 includes a benign classification, the third processed data stream 750 may comprise some, or all, of the data included in the input data stream 740. In an embodiment, if the third meta data 770 includes a malicious classification, there may be some data in the input data stream 740 that are not included in the third processed data stream 750.

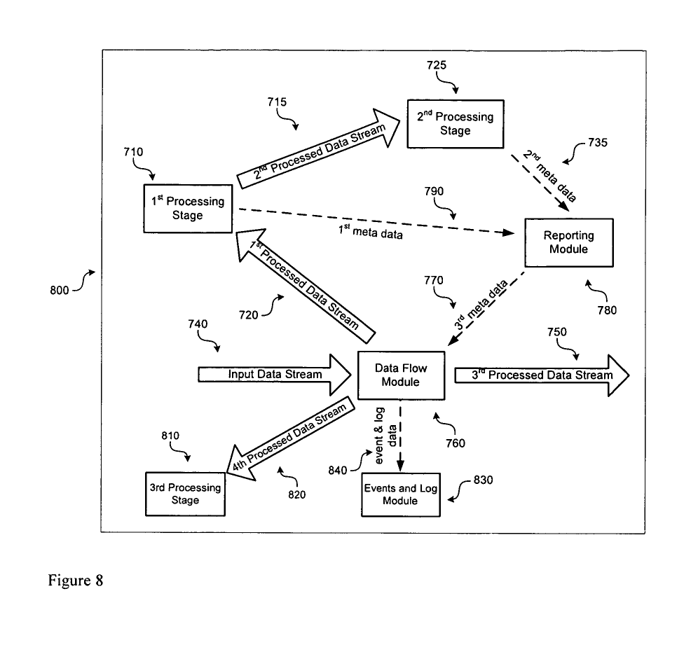

FIG. 8 shows various logical blocks of system 800 adapted to detect malicious data, in accordance with another embodiment of the present invention. In system 800, the data flow module 760 is extended to derive a fourth processed data stream 820 that is transmitted to a third processing stage 810.

In some embodiments of system 800, the third processing stage 810 is a quarantining module, or other processing module, that accepts, as the fourth processed data stream 820, at least the portion of the input data stream 740 that has been classified malicious. In an embodiment in which the third processing stage 810 is a quarantining module, the data contained in the fourth processed data stream 820 is directed to a storage medium wherein it could be later examined or from which it could later be extracted. Examples include virus scanning systems that scan disk files, moving those files which are found to contain one or more viruses to a dedicated disk storage location for later processing or inspection. Other examples include email processing systems that redirect virus infected email messages to an alternate delivery location. Further examples include virus scanning HTTP proxies or other HTTP agents which redirect infected HTTP data to a designated storage location.

In the system shown in FIG. 8, data flow module 760 produces event and log data 840 as the fourth meta data 730 (also see FIG. 7). This event and logging information is transmitted to an events and log module 830. In an embodiment, event and log data 840 form the basis of the reporting and feedback generated when the system is operated.

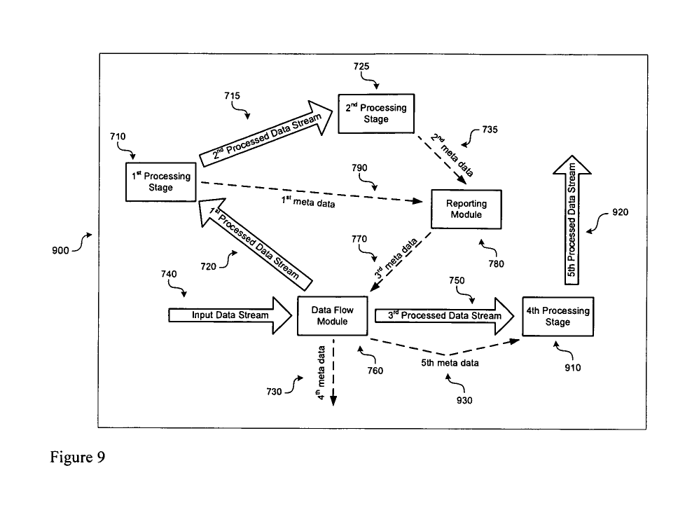

FIG. 9 shows various logical blocks of a system 900 adapted to detect malicious data, in accordance with another embodiment of the present invention. System 900 includes, among other blocks, a fourth processing stage 910, a fifth meta data 930 and a fifth processed data stream 920. Fourth processing stage 910 comprises a disinfection module, said disinfection module being a module configured to retransmit its input data 750 as its output data 920 after the removal of malicious data from the stream. The removal of such malicious data is controlled by the information contained in the fifth meta data 930.

In an embodiment, system 900 also includes, in part, an electronic mail transfer system that removes viruses or other malicious data from email messages before passing said messages on to the addressee or other email handling systems. In other embodiments, system 900 includes, in part, HTTP proxies or other HTTP data handling systems wherein such systems remove malicious data from HTTP packets, or messages, before passing said packets, or messages, back to a user browser or other HTTP handling system. In other embodiments, system 900 performs malicious data scanning and filtering as part of data delivery. System 900 may be embodied in, for example, instant messaging systems, telephony systems, streaming data or multi-media systems, XML transmission systems; and office productivity systems that perform malicious data tests, removing inappropriate data as part of the file loading process.

In some embodiments, second processing stage 725 includes more than one processor. In such embodiments, the second processing stage 725 processes the data in the second processed data stream 715 using a processor that is selected using a method that relies on the type of the data in the second processed data stream 715. Such embodiments are configured to scan data for viruses or other malicious data, for example, to scan HTTP traffic, email traffic, instant messaging traffic etc.

Other embodiments include a multitude of modules or subsystems with corresponding multiple first processed data streams, multiple second processed data streams, multiple first meta data, and second meta data. In such embodiments there are multiple first processing stages and multiple second processing stages, each first processing stage receiving a corresponding first processed data stream, each second processing stage receiving a corresponding second processed data stream. Such embodiments are configured so that each first processing stage produces a first meta data and each second processing stage produces a second meta data. In such embodiments, the reporting module 780 is configured to receive multiple first meta data and multiple second meta data.

Embodiments of the present invention may be configured to be applicable to specific types of malicious data scanning and processing. Such embodiments include, without restriction, systems to process data to scan, for example, for viruses, spyware, malicious code, email viruses and macros, trojans, worms and any other form of malicious data or code. Such embodiments operate on data including but not limited to data in the form of email message, instant messaging traffic, telephony data, SMS data, multi-media or other streaming data, HTTP data, FTP data, web services data, other Internet protocol data, streams of undistinguished network packets, digital data stored on disk or other storage media, XML encoded data, and any other form of digital data.

A system, in accordance with any of the embodiments of the present invention may be configured so that the pre-filtering performed by the first processing stage 710 provides a speed improvement relative to prior art system which have a single processing stage, e.g., systems that do not have the first processing stage 710 and in which the second processing stage 725 receives the first processed data stream 720.

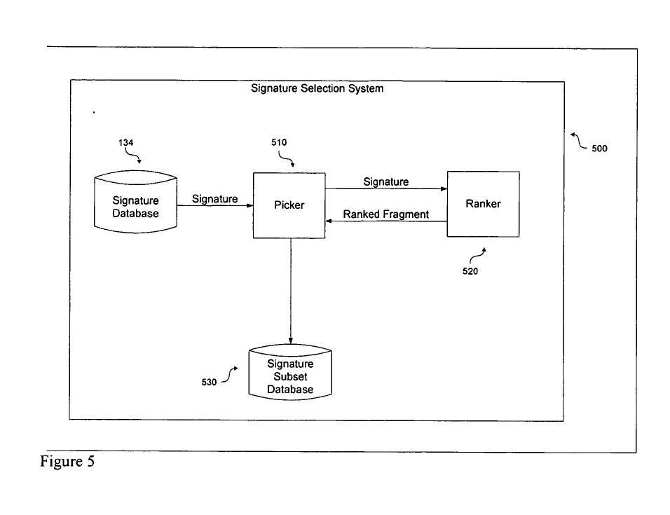

Embodiments of the present invention may process data using rule based pattern matching systems. For example, the rules used in the first processing stage 710 are derived from the set of rules used in the second processing stage 725. FIG. 5 depicts an embodiment of a system 500 for deriving the rules used in the first processing stage. In this system, a signature subset database 530 is derived from a signature database 134. In this embodiment, the picker 510 breaks the patterns from the signature database 134 in to fragments. These fragments are then ranked by the ranker. 520, using heuristics appropriate to the type of patterns included in the signature database. The picker 510 then selects the most appropriate pattern fragments, based on the ranking performed by the ranker 520. These fragments are stored in the signature subset database 530. The signature subset database is then used to configure the first processing stage 710.

Embodiments of the present invention may be configured so that the first processing stage 710 operating on the data in the first processed data stream 720, using the rules with which the first processing stage 710 has been configured, is able to process data more quickly than the second processing stage 725. Such embodiments may include systems in which the first processing stage 710 is able to completely process some data in the first processed data stream 720, the remainder of the data being transmitted in the second processed data stream 715.

In some embodiments, the second processing stage 725 may be a self-contained malicious data searching system, such as a standalone virus checking system. Typically in such embodiments, the first processing stage 710 is able to process data at a higher rate than a self-contained system that is incorporated as the second processing stage. The first processing stage 710 is used to classify some of the data in the first processed data stream 720, consequently reducing the amount of data sent to the second processing stage 725 and consequently achieving a higher overall system throughput. The systems of the present invention are thus able to process data more quickly than known self-contained systems that include a single stage, e.g., the second processing stage.

In some embodiments, various components of the system are configured with one or more signature databases. These signature databases are collections of patterns, rules or other search criteria that may be used to differentiate malicious, benign, or other classes of data. The term “signature subset database” is used to refer to a signature database that is derived from another signature database by selection, simplification, rewriting, or other appropriate processes.

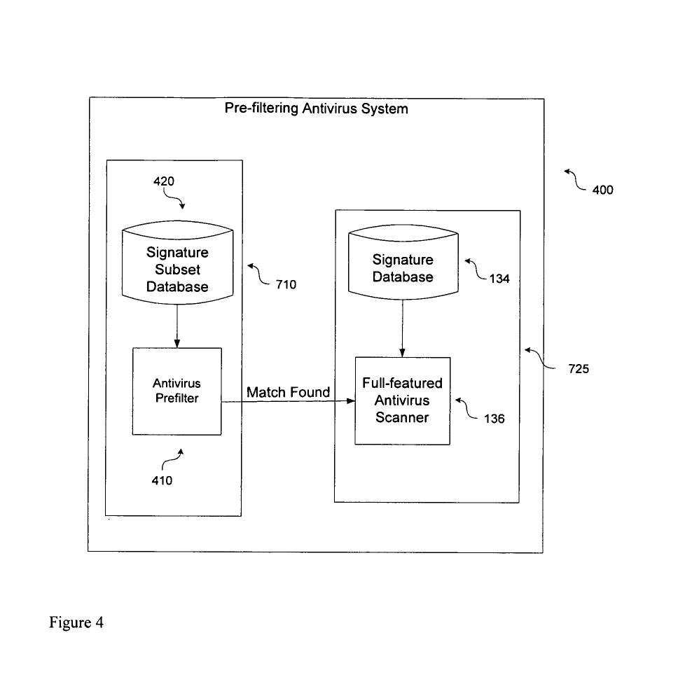

FIG. 4. shows various blocks of the first processing stage 710 and second processing stage 725, in accordance with an embodiment of the present invention. The first processing stage 710 is shown as including, in part, an antivirus pre-filter 410 coupled to a signature subset database 420. The second processing stage is shown as including, in part, a full-featured antivirus scanner 136 coupled to a complete signature database 134. The signature subset database 420 is derived form the complete signature database 134 such that the aggregate data throughput of the pre-filter stage 410 is higher than that of the second stage 136. Data is passed on to the second stage when the first stage detects the possibility of malicious data. The system is configured, through the derivation of the signature subset database 420 from the complete signature database 134, so as to ensure that a match against the complete signature database 134 is not possible for data that does not cause a match against the signature subset database 420. The first processing stage 710 and second processing stage 725 when configured to include the blocks shown in FIG. 4, reduce the amount of data traveling to the second stage 725, and consequently achieve a higher aggregate data throughput over known systems that use just the second stage 725 without the pre-filter stage 410.

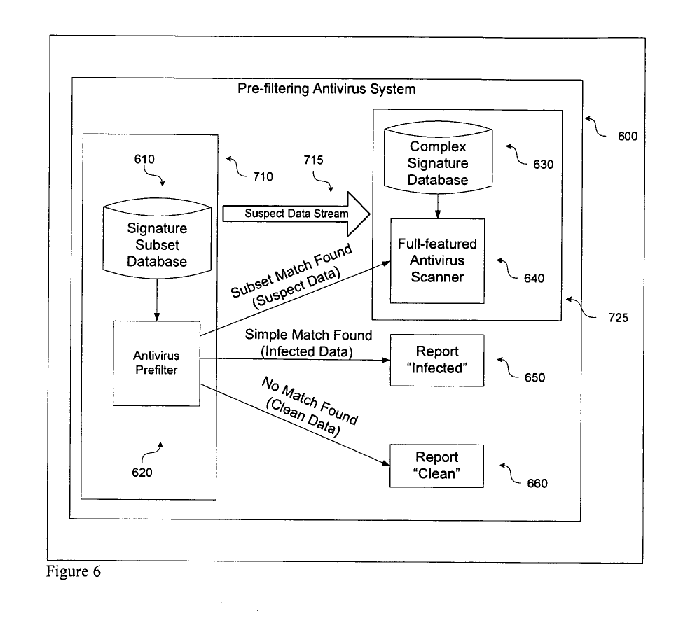

FIG. 6 shows blocks of first processing stage 710 and second processing stage 725, in accordance with yet another embodiment of the present invention, adapted to generate the first meta data 790 (see FIG. 7). First processing stage 710 is shown as including, in part, an antivirus pre-filter 620 coupled to a signature subset database 610. The second processing stage 725 is shown as including, in part, a full-featured antivirus scanner 640 coupled to a complex signature database 630.

The blocks, 610 and 620, forming the first processing stage 710 of FIG. 6 are configured to classify the first processed data stream (see FIG. 7) as clean, infected or suspect. If the first processing stage classifies the data as clean, a “clean” message is generated as the first meta data 790. This is depicted in FIG. 6 by the report clean operation 660. If the first processing stage classifies the data as infected, an “infected” message is generated as the first meta data 790. This is depicted in FIG. 6. by the report infected operation 650. If the first processing stage 710 classifies the data as suspect, the data is passed to the second processing stage 725, which is shown as including blocks 630 and 640, for further processing. If the data is classified as suspect, the suspect data is sent as the second processed data stream 715. An anti-virus detection system, in accordance with any of the embodiments of the present invention, and that includes the first processing stage and second processing stage, as described herein and shown in the drawings, is able to achieve a higher aggregate data throughput by reducing the amount of data that is transmitted to the slower second processing stage, and thus is faster than prior art systems which do not include two processing stages.

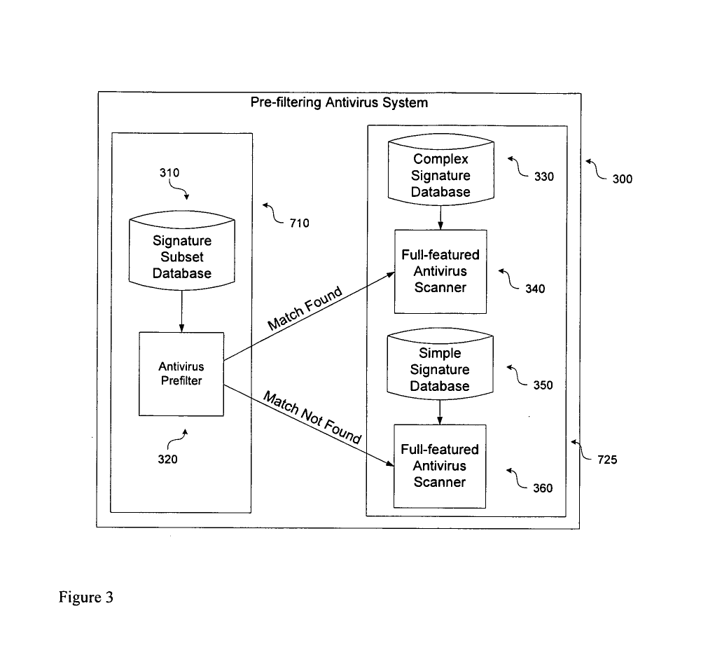

FIG. 3 shows various blocks of first processing stage 710 and second processing stage 725, in accordance with yet another embodiment of the present invention, each of which stages is configured to scan for viruses. The first processing stage 710 is shown as including, in part, an antivirus prefilter 320 coupled to a signature subset database 310 that includes a database of rules and that allows high-speed scanning. In an embodiment, the first processing stage 710 performs antivirus scanning using a security device, that may include one or more hardware logic (not shown) configured to perform high speed pattern matching. One or more rules from the specific database of rules 310 are loaded into the security device and made available to the hardware logic during pattern matching operations. The hardware logic may be reconfigurable in the field. For example, the hardware logic may be a field programmable gate array (FPGA), thus allowing the hardware logic to be upgraded and modified in the field.

The antivirus prefilter 320 is configured to determine whether the scanned data contains a virus represented by a rule in the signature subset database 310, where the signature subset database 310 is derived from the complex signature database 330. If the data is classified as containing a virus using a signature derived from the complex signature database 330, then the data is passed to a first full-featured antivirus scanner 340 that has been configured with a complex signature database 330. If the data is classified as not containing such a virus, then the data is passed to a second full-featured antivirus scanner 360 that has been configured with a simple signature database 350. The antivirus prefilter 320 and the second full-featured antivirus scanner 360 are configured to operate at a higher throughput than the first full-featured antivirus scanner 340. By reducing the amount of data that flows through the first full-featured antivirus scanner 340, the system is able to achieve a higher aggregate throughput than a system that includes only the first full-featured antivirus scanner 340.

The above embodiments of the present invention are illustrative and not limitative. Various alternatives and equivalents are possible. The described data flow of this invention may be implemented within separate networks of computer systems, or in a single network system, and running either as separate applications or as a single application. The invention is not limited by the type of integrated circuit in which the present disclosure may be disposed. Nor is the disclosure limited to any specific type of process technology, e.g., CMOS, Bipolar, or BICMOS that may be used to manufacture the present disclosure. Other additions, subtractions or modifications are obvious in view of the present disclosure and are intended to fall within the scope of the appended claims.

What is claimed is:

1. A data classification system configured to identify and process malicious data in electronic data, the system comprising:
a data flow module configured to generate a first processed data stream from an input data stream, the data flow module being further configured to receive a third meta data from a reporting module and to generate a third processed data stream from the received input data stream and the third meta data;
a first processing stage configured to receive the first processed data stream and to generate a second processed data stream and a first meta data from the first processed data stream;
a second processing stage configured to receive the second processed data stream and generate a second meta data therefrom; and
a reporting module configured to receive the first meta data and the second meta data and to generate the third meta data.

2. The system of claim 1 wherein the first processing stage is further configured to classify data included in the first processed data stream into a first classification result defined as being one of at least a first or second classifications types.

3. The system of claim 2 wherein said first classification type represents benign data and said second classification type includes potentially malicious data.

4. The system of claim 3 wherein said first meta data includes the first classification result.

5. The system of claim 4 wherein said second processed data stream includes at least a part of the first processed data stream if the first classification result includes the second classifications type, wherein said second processed data streams excludes at least a part of the first processed data stream if the first classification result includes the first classifications type.

6. The system of claim 1 wherein the second processing stage is further configured to classify data included in the second processed data stream into a second classification result defined as being one of at least a first or second classification types.

7. The system of claim 6 wherein said first classification type represents benign data, and wherein said second classification data type represents malicious data.

8. The system of claim 7 wherein said second meta data includes the second classification result.

9. The system of claim 1 wherein said reporting module is further configured to generate one of a clean or infected signal from the first and second meta data, wherein said clean or infected signal is included in the third meta data.

10. The system of claim 9 wherein the third processed data stream includes a part of the input data stream if the third meta data includes the clean signal.

11. The system of claim 9 wherein the third processed data stream excludes a part of the input data stream if the third meta data includes the infected signal.

12. The system of claim 13 further comprising:
an events and logs module configured to receive and process events and logs data generated from the received input data stream and third meta data by the data flow module.

13. The system of claim 1 further comprising:
a third processing stage configured to receive and process a fourth processed data stream generated from the received input data stream and third meta data by the data flow module.

14. The system of claim 13 wherein said third processing stage is further configured to quarantine the fourth processed data stream, wherein said fourth processed data stream includes at least a part of the input data stream.

15. The system of claim 1 wherein said data flow module is further configured to output a fourth meta data generated from the received input data stream and the third meta data, wherein said fourth meta data includes a clean or infected signal, and wherein said third meta includes a clean or infected signal, generated from the third meta data further comprising:
a disinfection module configured to receive the third processed data stream and the fourth meta data and to generate, in response, a fifth processed data stream.

16. The system of claim 15 wherein if the fourth meta data includes the infected signal then the disinfection module processes malicious data included in the received third processed data stream using the fourth meta data, wherein said processing of malicious data by the disinfection module renders the malicious data included in the third processed data stream harmless, wherein said fourth meta data includes malicious data information generated from malicious data information included in the third meta data, wherein said reporting module derives malicious data information included in the third meta data from the first and second meta data, wherein the rendered harmless data and the third processed data stream is included in the fifth processed data stream.

17. The system of claim 16 wherein said first processing stage is further configured to generate malicious data information using the received first processed data stream, the first processing stage being configured to include the malicious data information in the first meta data, wherein said first meta data is transmitted to the reporting module.

18. The system of claim 16 wherein said second processing stage is further configured to generate malicious data information using the received second processed data stream, the second processing stage being configured to include the malicious data information in the second meta data, wherein said second meta data is transmitted to the reporting module.

19. The system of claim 16 wherein said disinfection module renders the data included in the fifth processed data stream harmless by removing the malicious data.

20. The system of claim 15 wherein said disinfection module is further configured to include a part of the input data stream in the fifth processed data stream if the fourth meta data includes a clean signal.

21. The system of claim 2 wherein said first processing stage is configured to classify the first processed data stream using at least a first set of rules, wherein said second processing stage is configured to classify the second processed data stream using at least a second set of rules, wherein said first set of rules is derived from the second set of rules.

22. The system of claim 2 wherein said input data stream includes one or more network packets.

23. The system of claim 2 wherein said input data stream includes one or more e-mail messages.

24. The system of claim 2 wherein said input data stream includes HTTP traffic.

25. The system of claim 2 wherein said input data stream includes XML-encoded network traffic and other data.

26. The system of claim 2 wherein said input data stream includes Voice-over-IP (VoIP) network traffic, instant messaging traffic, and telephony traffic.

27. The system of claim 2 wherein said input data stream includes files provided by a memory storage device.

28. The system of claim 27 wherein said memory storage device includes primary storage devices, secondary storage devices, random access memories, hard disks and tape drives.

29. The system of claim 2 wherein said first processing stage is further configured to generate the first processed data stream using a first processor if the first processed data stream includes a first type of data stream, the first processing stage being configured to generate the first processed data stream using a second processor if the first processed data stream includes a second type of data stream.

30. The system of claim 2 wherein said second processing stage is further configured to generate the second processed data stream using a third processor if the second processed data stream includes a third type of data stream, the second processing stage being configured to generate the second processed data stream using a fourth processor if the second processed data stream includes a fourth type of data stream.

31. The system of claim 2 wherein said system is further configured to identify and process viruses, spyware and other malware.

32. The system of claim 2 wherein said data flow module is an HTTP proxy.

33. The system of claim 2 wherein said first processing stage further comprises a security device configured to perform security processing, the security device including one or more hardware logic, wherein said hardware logic is configured to perform high speed data processing.

34. The system of claim 33 wherein said hardware logic is reconfigurable.

35. A method for identifying and processing malicious data in electronic data, the method comprising:
receiving an input data stream,
processing the input data stream to generate a first processed data stream,
processing the first processed data stream to generate a second processed data stream and a first meta data,
processing the second processed data stream to generate a second meta data,
processing the first meta data and the second meta data to generate a third meta data, and
processing the third meta data and the input data stream to generate a fourth meta data and a third processed data stream.

36. The method of claim 35 wherein the processing of the first processed data stream includes classifying data in the first processed data stream as one of at least a first or second data classifications, wherein said first data classification represents benign data, wherein said second data classification represents potentially malicious data, wherein at least one of the first or second data classifications is included in the generated first meta data.

37. The method of claim 36 wherein the second processed data stream includes a part of the data included in the first processed data stream if the result of classifying the first processed data stream represents potentially malicious data, wherein the second processed data stream excludes a part of the data included the first processed data stream if the result of classifying the first processed data stream represents benign data.

38. The method of claim 35 wherein the processing of the second processed data stream includes classifying data included in the second processed data stream as one of at least a first or second data classifications, wherein said first data classification represents benign data, wherein said second data classification represents malicious data, wherein at least one of first or second data classifications is included in the generated second meta data.

39. The method of claim 35 wherein said third meta data includes a clean or infected signal generated from the first meta data and the second meta data.

40. The method of claim 39 wherein said third processed data stream includes a part of the data included in the input data stream if said signal included in the third meta data is the clean signal, wherein said third processed data stream excludes does not include a part of the data included the input data stream if said signal included in the third meta data is the infected signal.

41. The method of claim 35 further comprising:
processing the input data stream and the third meta data to generate a fourth processed data stream, said fourth processed data stream including at least a part of the input data stream; and
quarantining the data in the fourth processed data stream.

42. The method of claim 35 further comprising:
generating a fourth meta data by processing the input data stream and the third meta data, wherein said fourth meta data contains at least a clean or an infected signal; and
generating a fifth processed data stream from the third processed data stream and the fourth meta data, wherein if said third processed data stream includes a first form of malicious data then the fifth processed data stream does not include the first form of malicious data.

43. The method of claim 35 wherein said processing of the first processed data stream utilizes at least a first set of rules, wherein said processing of the second processed data stream utilizes at least a second set of rules, wherein said first set of rules is derived from the second set of rules.

44. The method of claim 35 wherein the input data stream includes one or more of networks packets, e-mail messages, HTTP traffic, XML-encoded data, Voice-over-IP-data, instant messaging data, telephony data, data from a memory storage device, wherein said memory storage device includes one or more of primary storage devices, secondary storage devices, random access memories, hard disks and tape drives.

45. The method of claim 35 wherein said processing of each of one or more of the input data stream, the first processed data stream and the second processed data stream includes one or more processing steps carried out in accordance with type of data contained therein.

46. The method of claim 35 wherein the malicious data identified is selected from a group consisting of viruses, spyware or malware.
